(19) United States
(12) Patent Application Publication
(10) Pub. No.: US 2009/0132445 A1
(43) Pub. Date: May 21, 2009

(54) GENERALIZED REDUCED ERROR LOGISTIC REGRESSION METHOD

(76) Inventor: Daniel M. Rice, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/119,172

(22) Filed: May 12, 2008

Related U.S. Application Data
(63) Continuation-in-part of application No. 11/904,542, filed on Sep. 27, 2007.

(51) Int. Cl. G06F 15/18

(52) U.S. Cl. 706/12; 901/50

(57) ABSTRACT

A machine classification learning method titled Generalized Reduced Error Logistic Regression (RELR) is presented. The method overcomes significant limitations in prior art logistic regression and other machine classification learning methods. The method is applicable to all current applications of logistic regression, but has significantly greater accuracy using smaller sample sizes and larger numbers of input variables than other machine classification learning methods including prior art logistic regression.

### CROSS-REFERENCE TO RELATED APPLICATIONS

This application is a continuation-in-part based upon U.S. non-provisional application Ser. No. 11/904,542, filed Sep. 27, 2007.

### STATEMENT REGARDING FEDERALLY SPONSORED RESEARCH

Not Applicable.

### FIELD OF THE INVENTION

This application is a continuation-in-part based upon U.S. non-provisional application Ser. No. 11/904,542, filed Sep. 27, 2007.

### BACKGROUND OF THE INVENTION

Automated classifications systems are an integral part of the fields of data mining and machine learning. Since the pioneering work of Luce (1959), there has been widespread use of logistic regression as an analytical engine to make classifying decisions. Examples of its application include predicting the probability that a person will get cancer given a list of their environmental risk factors and genes, predicting the probability that a person will vote Republican, Democratic or Green given their demographic profile, and predicting the probability that a high school student will rank in the bottom third, the middle third, or the upper third of their class given their socioeconomic and demographic profile. Logistic Regression has potential application to any scientific, engineering, social, medical, or business classification problem where target variable values can be formalized as binary, multiple category, rank, or interval-categorized outcomes. More generally, Logistic Regression is a machine learning method that can be programmed into computers, robots and artificial intelligence agents for the same types of applications as Neural Networks, Random Forests, Support Vector Machines and other such machine learning methods, many of which are the subject of issued U.S. patents. Logistic Regression is an important and widely used analytical method in today's economy. Unlike most other machine learning methods, Logistic Regression is not a “black box” method. Instead, Logistic Regression is a transparent method that does not require elaborate visualization methods to understand how the classification works.

Prior art forms of logistic regression, along with other machine classification methods, have significant limitations with regard to their ability to handle errors such as sampling errors in small training sample sizes, overfitting error, and multicollinearity error related to highly correlated input variables. Many prior art logistic regression methods also do not handle high dimensional problems having very large numbers of variables effectively.

The present machine learning method is fundamentally different from prior art methods such as the one described in U.S. Pat. No. 7,222,127 (the '127 patent). For example, the method of the present invention is based upon reduced error processing that can be shown to yield less error in machine learning applications with abundant error, and the method of the present invention employs backward selection in all of its variable selection and variable deletion processing. In contrast, the '127 patent employs additive or forward selection in its variable selection and further employs an arbitrary cost function in its objective function that is fundamentally different from reduced error processing.

The present disclosure is directed to improvements in a method for Generalized Reduced Error Logistic Regression which overcomes significant limitations in prior art logistic regression and early theoretical work disclosed by the Applicant in 2005 and 2006 that preceded what is currently known as RELR. The method of the present invention is applicable to all current applications of logistic regression. The present method effectively deals with error and dimensionality problems in logistic regression, and therefore has significantly greater reliability and validity using smaller sample sizes and potentially very high dimensionality in numbers of input variables. These are major advantages over prior art logistic regression methods. In addition, this improved method has elaborate variable selection and deletion methods and optimally scales the model with an appropriate scale factor Ω that adjusts for total variable importance across variables to calculate more reliable and valid logit coefficient parameters generally.

The present method is a continuation-in-part of U.S. patent application Ser. No. 11/904,542 also titled Generalized Reduced Error Logistic Regression Method. The major changes from the method described in this previous application are:

1. the present application clears up ambiguities and clerical errors in some of the formulas presented in application Ser. No. 11/904,542.

2. In contrast to the method described in application Ser. No. 11/904,542, the present application presents a new Variable Deletion process which provides more parsimonious solutions.

3. In addition, the method of the present invention does not weight the “largest expected error” as defined in Equation 5a by 1/sqrt(Nᵣ) as was done in application Ser. No. 11/904,542. Instead, a weight of 1/sqrt(N_{r′}/Nᵣ) is applied, as this now handles a distinction between independent vs. dependent observations. When all Nᵣ non-missing observations for a given input variable are independent, then N_{r′}=Nᵣ and this new weighting will be identical to the theoretical work disclosed by applicant at the Psychometric Society Meetings in 2005 and 2006. Nevertheless, even in this case where N_{r′}=Nᵣ, Equation 5a will give different solutions than the previously presented theoretical work. The reason is that a scale factor akin to the current Ω in Equation (5a) was fundamentally different in this early theoretical work where it reflected the “largest possible value that gives a solution”. As it turns out, such a scale factor does not work because it gives solutions with large amounts of error and this was described in application Ser. No. 11/904,542. The scale factor now presented in this application is defined in Equation 5b for non-ordered models and Equation 5d for ordered models and was first described in application Ser. No. 11/904,542. Although the current weighted measure is biased in these equations, the nature of the bias favors solutions with smaller numbers of variables or less missing data and this is a desirable outcome.

4. In addition, the method of the present invention adds a different t measure in the form of Equation 5c for rank and interval-categorized target variables. application Ser. No. 11/904,542 employs a t-test that required categorizing these types of variables into binary variables.

5. The method of the present invention now adds the ability to model patterns of missing vs. non-missing observations on input variables that have a structural relationship to the target variable.

6. The method of the present invention now allows a user to control the number of observations that are used in the variable selection phase to construct weighted t values. For models with very large numbers of observations and very large numbers of variables, this will yield an enormous savings in computational time without significant loss in model accuracy.

7. The method of the present invention now allows for hierarchical rules for interactions to govern variable selection and deletion as is sometimes done in genomic models. This option is under user control, but is not arbitrary and is instead determined by unique features of an application.

8. The method of the present invention now employs a threshold to determine the classification output decision for the reference vs. non-reference classification. This option is under user control, but is not arbitrary. Instead, it is normally set to the threshold associated with the least amount of bias in the classification unless unique features of an application indicate otherwise.

9. The results harts now change slightly for RELR and because we now use the appropriate McNemar statistics for dependent portions. In addition, we found that we could get a better SVM model for the large sample political polling model (FIG. 3), so SVM fares better in these comparisons.

10. Finally, the method of the present invention includes a measure of model performance that is used as a measure of the best model. This is referred to as the Adjusted Log Likelihood.

### SUMMARY OF THE INVENTION

Machine learning methods are typically applied to data sets to generate a classification model. The simple three layer feed-forward network composed of input-decision-output layers is basic to systems that exhibit classification learning. Classification systems typically employ this architecture and RELR is no exception. However, RELR is able to reduce the error within this type of classification processing compared to current standard machine learning processes including standard logistic regression. Therefore, a significant advantage of the method of the present RELR method is how computations are made within this classification architecture, as these computations can lead to a significant reduction of error in machine learning processing. In addition, the present method is able to handle problems associated with very high dimensionality more effectively than prior art logistic regression methods because of RELR's ability to build models based upon a small set of most important variables.

The method of the present invention provides a very broad, new machine learning process. This RELR method works for those problems where standard logistic regression does not. The RELR method also appears to work as well as standard logistic regression in low error problems where standard logistic regression works quite well. RELR can be used with binary, multiple category, rank, or interval-categorized target variables. Since continuous target variables always can be encoded as interval-categorized variables, it can be applied in practice to continuous variables after they are recoded. Input variables can be nominal, ordered, and/or continuous. Also, RELR works with input variables that are interactions to whatever order is specified in the model. The process works with many input variables, and also allows modeling of non-linear effects in input variables up to a 4th order polynomial component. Optionally, users can decide to model only linear variables RELR handles the dimensionality problem relating to large numbers of variables by effectively selecting variables prior to building a model to include only the most important variables in the logistic regression model.

The data presented in this application suggest that RELR can have significantly less error than five standard machine learning methods in datasets involving small sample sizes and/or large numbers of informative, correlated variables. These comparison methods included Support Vector Machine, Neural Network, Decision Tree, Partial Least Squares, and Standard Forward-Select Logistic Regression.

Other objects and features will be in part apparent and in part pointed out hereafter.

### BRIEF DESCRIPTION OF THE SEVERAL VIEWS OF THE DRAWINGS

FIG. 1 is a depiction of the three layer feedforward network structure;

FIG. 2 is a chart that compares RELR misclassification error to that from five standard machine learning methods in models built from a dataset with a small sample of training observations and many correlated important variables;

FIG. 3 is a chart that compares RELR misclassification error to that from five standard machine learning methods in models built from a dataset with a larger sample of training observations and many correlated important variables;

FIG. 4 is a chart that compares RELR misclassification error to that from five standard machine learning methods in models built from a dataset with a larger sample of training observations and few important variables.

### DESCRIPTION OF THE PREFERRED EMBODIMENT

### Model Generation and Output Network

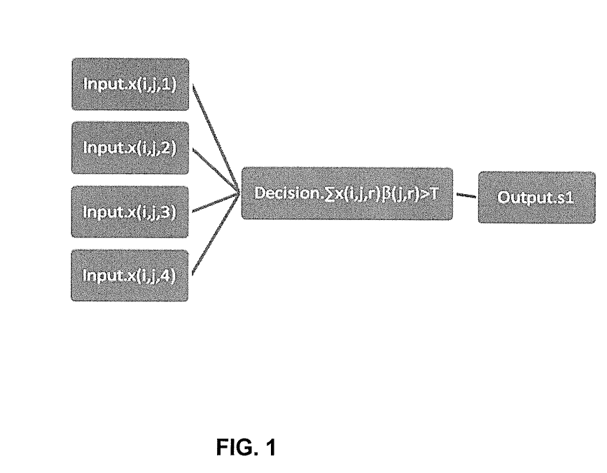

Classification systems typically rely upon a network that encompasses three types of layers: input nodes, decision nodes, and output nodes. The input nodes define the variables that are input variables; and there can be millions of such input variables in some high dimensional complex problems. The decision node computes the probability or some other indicator of a given class based upon the input variables, associated weights, and a threshold. Finally, the output nodes carry the decision that is made based upon the decision node probability results and often become other input nodes in a larger network. Such nodes can be connected in simple feedforward networks as shown in FIG. 1.

In addition to the FIG. 1 network, there can be other more complicated network structures that include feedback, so that output nodes can connect to other networks that either cycle back and become input nodes to the same network or interface with different networks in a much larger system. When learning from previous classification successes and failures is allowed to influence a future classification, the decision nodes may weight the values of the input variables to increase or decrease the probability of a given class. In this way, such networks can store previous learning through these weightings. For example, in this FIG. 1 network, previous learning is continually stored by updating the weights β(j,r) to reflect the history of observations given to this network in training. Such updates in storage weights β(j,r) are done by individual observation or by epochs of observations. Also, prior to being exposed to observational learning, a network can have prior Bayesian weightings β(j,r) based upon prior weightings on the inputs, including uniform weightings across all inputs. These are just some of the many possibilities and these possibilities can become endless when input-decision-output node networks are joined together to form larger networks that allow feedback and the storage of previous learning. This invention does not address the architecture of input-decision-output node networks, as such networks that are basic to learning systems. An example of this type of input-decision-output structure is the neuron. In this case, graded potentials passed down dendrites form the inputs, the summation of these graded potentials in the axon hillock forms the decision probability summation for the threshold point, and the all-or-none neural impulse passed down the axon forms the output component.

One point of novelty of the present invention is how the weights that form the basis of the decision in the decision node are computed. The computation that is necessary to form these weights takes place in a logistic regression based classification system. It is assumed that RELR would be useful in generating these decision weights whether the network is a very simple and naïve feed-forward network such as in FIG. 1, or is a complicated feedback network composed of many sub-networks built from the FIG. 1 network.

One very simple physical implementation of the input-decision-output feedforward network would be to have the input layer be a database that resides on a computer that runs as a database server and defines all relevant input variables for RELR. The decision node could be a separate computer that takes the input variables and runs the RELR method through appropriate software, and the output node could be an on-off switch that connects to a physical device such as an alarm that is turned on or off as a function of the probability results of RELR and the decision threshold. In this implementation, RELR could be trained to learn a classification of alarm vs. non-alarm states based upon the historical database of observations residing on a server.

As another example, the output node need not connect to an operational device but instead might connect to a computer terminal screen or printer. For example, the input node might be a database residing on a server that contains enormous numbers of genetic variables in relation to disease outcomes in a human population sample, the decision node might be a supercomputer that is programmed to run the RELR method and update its output models based upon new information, and output nodes might be connected to a computer visual screen that informs a physician the diagnostic category that RELR gives to a given patient given the probability and threshold information that is computed. In a similar fashion, the input layer might be a marketing or financial database residing on a server, the decision layer might be a separate server that is programmed to run RELR and the output node would display the results of RELR through a computer visual screen to an analyst or statistician. This is a very typical business analytics application of machine learning in today's business environment.

As another example, RELR need not be implemented in software but instead might be implemented through a hardware chip. In this example, the input layer might be a database of sensory variables that arise from a robot's interactions with its environment, the decision layer might be a computer chip that automatically computes reinforcement and punishment classification learning models according to the RELR method and scores input data based upon these models, and the output layer might be connected to the robot's limbs to change its behavior as a function of RELR's decision threshold output. Such a robotic system could also produce feedback inputs for the reinforcement or punishment classification learning through its interactions with the environment.

The basic three layer feedforward network is a very general network for such supervised classification learning where training is involved that employs a target classification variable. It would apply to the simple uses of machine learning as when an analyst is using a database to generate a predictive model in a business application to make a business decision. It would also apply to the most complicated applications involving robotic learning where feedback with the environment is critical. The point is that RELR is a generalized machine learning method that defines how classification decisions are computed across all supervised machine classification learning applications.

Model Generation and Output Processing

A network is trained through supervised learning to make a decision by repeatedly or simultaneously observing associations between values of input variables on the input nodes and values of the classification variable that is being learned. These values of the classification membership across observations are known as the target variable. In logistic regression, a probability is computed that measures this association between a set of input node values and the target variable. In logistic regression, the decision rule that determines whether this probability is greater than a threshold can be expressed in terms of the simple linear summation rule shown in FIG. 1. The weights that are the basis of this probability are the essence of what is learned; there is a weight for each input variable. RELR computes these weights in a decision node. RELR's approach to computing these weights differs from existing logistic regression methods in that it employs an optimization approach designed to reduce the error in such computations. The output or decision of the model is based upon thresholds that determine the class that a given probability indicates. Once RELR has been trained to classify observations into two or more classes, observations can be automatically scored by RELR to provide probabilities of class membership and most likely class membership based upon relevant thresholds. Once again, the novelty to RELR does not concern the physical architecture of such model generation and output processing, as this architecture is basic to classification learning systems. Instead, the novelty is in how this processing is accomplished. These novel features involve a detailed methodology and this method is described below.

A Maximum Entropy Model

The present Generalized RELR method is based upon the maximum entropy subject to linear constraints formulation that Soofi (1992) showed to be equivalent to the McFadden (1974) maximum likelihood logit formulation and Golan et al. (1996) further developed to model error probabilities. The major additions to this prior art are extensions to handle nonlinear variables, interaction variables, symmetrical extreme error probabilities with correct scaling, ordinal target variables, non-independent observations, variable selection, and variable deletion, as all of these extensions are necessary for a generalized supervised machine classification learning method. In this formulation, we seek the maximum of the entropy function H(p,w:

$$\begin{matrix}H ( p , w ) = - {\sum }_{i = 1}^{N} {\sum }_{j = 1}^{C} {p}_{ij} ln ( {p}_{ij} ) - {\sum }_{l = 1}^{2} {\sum }_{r = 1}^{M} {\sum }_{j = 1}^{C} {w}_{ljr} ln ( {w}_{ljr} ) \\ subject to linear constraints that include \text{:} & ( 1 ) \\ {\sum }_{i = 1}^{N} {\sum }_{j = 1}^{C} ( {x}_{ijr} {y}_{ij} ) = {\sum }_{i = 1}^{N} [ {\sum }_{j = 1}^{C} ( {x}_{ijr} {p}_{ij} ) + ( {u}_{r} {w}_{1 jr} - {u}_{r} {w}_{2 jr} ) ] \\ for r = 1 to M . & ( 2 ) \\ {\sum }_{j = 1}^{C} {p}_{ij} = 1 for i = 1 to N & ( 3 ) \\ {\sum }_{j = 1}^{C} {w}_{jlr} = 1 for l = 1 to 2 and r = 1 to M & ( 4 ) \\ {\sum }_{i = 1}^{N} {y}_{ij} = {\sum }_{i = 1}^{N} {p}_{ij} for j = 1 to C - 1 , & ( 5 )\end{matrix}$$

where C is the number of choice alternatives, N is the number of observations and M is the number of data moment constraints.
where C is the number of choice alternatives, N is the number of observations and M is the number of data moment constraints.

The constraints given as Equation (5) are intercept constraints. These are presented for sake of generality, but with a dichotomous response variable it makes sense to drop the j=1 intercept from the model and instead use a probability threshold to ensure no response accuracy bias in the scored decisions. This threshold level is under user control, but unless exceptional modeling circumstances dictate otherwise, it is useful to use a threshold that gives minimal response bias in terms of the hit rate vs. the correct rejection rate. The learning of this unbiased probability threshold computation is a trial and error process where the response accuracy bias is assessed at a sampling of all possible threshold levels in the training data and the threshold point at which response bias is minimal is selected.

In the case of non-ordered categorical data with more than two alternatives C, the reference choice condition j=C should be chosen to reflect the multinomial category with the largest number of responses. This ensures that the t value described below is the most stable possible value. This reference choice condition does not matter with only two alternatives.

In this formulation, yᵢⱼ=1 if the ith individual chooses the jth alternative from the choice set and 0 otherwise. Also, xᵢⱼᵣ is the rth characteristic or attribute associated with the ith individual who perceives the jth choice alternative, so xᵢⱼ is a vector of attributes specific to the jth alternative as perceived by the ith individual and xᵢ is a vector of characteristics of the ith individual. In addition to representing non-interactive features of the individual or the choice, an individual xᵣ vector also can represent an interaction where each interaction vector is formed in the usual way as a product of characteristics and/or attributes. The pᵢⱼ term represents the probability that the ith individual chooses the jth alternative and wⱼₗᵣ represents the probability of error across individuals corresponding to the jth alternative and rth moment and lth sign condition. When l=1, wⱼₗᵣ represents the probability of positive error. When l=2, wⱼₗᵣ represents the probability of negative error.

The uᵣ term is a measure of the largest expected error for the rth moment. The fact that the error term is the “largest expected error” is consistent with the Extreme Value Type I properties of the Logit error. It is defined as:

$$\begin{matrix}{u}_{r} = Ω / {t}_{r} sqrt ( {N}_{r} , / {N}_{r} ) for r = 1 to M . & ( 5 a ) \\ where Ω is defined as \text{:} & \\ Ω = {\sum }_{r = 1}^{M} \vert {t}_{r} \vert sqrt ( {N}_{r} , / {N}_{r} ) for r = 1 to M . & ( 5 b )\end{matrix}$$

The tᵣ value in Equation (5a) reflects the t value from a one sample t-test that compares those non-missing values of xᵢᵣ in the reference choice condition to non-missing values of xᵢᵣ in all other choice conditions. This one sample t-test is possible because effect coding of −1 and 1 is multiplied by each xᵢᵣ as a function of whether yᵢⱼ is in the reference choice condition or not. When this t value is small, then this extreme error value defined by uᵣ is large. When this t value is relatively large, then this uᵣ extreme error value is relatively small. Nᵣ reflects the number of non-missing observations across all xᵢᵣ, i=1 to N observations whether or not these are independent observations, whereas N_{r′} is a count of the number of such non-missing independent observations. Ω is a positively valued scale factor that is the sum of the magnitude of the denominator of Equation (5a) across all r moments. If we take the magnitude of each tᵣ to reflect the extent to which the rth moment is informative, then the sum of these magnitudes across all r moments to define Ω in Equation (5b) reflects the extent to which all moments are informative.

Assuming that not all target variable values are the same and not all input variable values are the same, it will be noted that there are at least four distinct values of the observations that go into the one sample t value resulting from the product of the standardized variable xᵢᵣ and a weight of 1 or −1. This would be true even when the original input variable from which this was derived was a binary variable. Even for what was originally a binary variable, the interval between these distinct values of the product of the standardized xᵢᵣ and 1 or −1 does have meaning in terms of an interaction between the relative distance from the expected average value of zero and whether or not the observation is in the reference choice condition. Hence, the t value should be interpretable as if this is an interval variable, even when the original variable used to create it was binary. Note that the t value cannot equal zero, so moments that have zero in the denominator should be excluded from a model.

### MOMENT DEFINITIONS

With the understanding that w reflects the probability of error when only a linear component is measured for the error probabilities, the following information gives the structure of the moment constraints in Equation (2) where higher order polynomial components are also measured for these information moments. The first M/2 set of data moments are from r=1 to M/2 and reflect the most important linear or cubic components as defined below through variable selection. The second M/2 set of data moments are from r=M/2+1 to M and reflect the most important quadratic or quartic components as defined below through variable selection. Nominal input variables are recoded into binary variables for each category condition to be accepted as inputs within this structure.

1) linear components: The linear constraints are formed from the original input variables. These constraints are standardized so that each vector xᵣ has a mean of 0 and a standard deviation of 1 across all C choice conditions and N observations that gave appropriate non-missing data. When missing data are present, imputation is performed after this standardization by setting all missing data to 0. When interactions are present, the vector xᵣ corresponding to each interaction variable is also standardized and imputed in the same way. Finally, in order to model missing vs. non-missing patterns of observations in input variables that are correlated to the target variable, new input variables are also formed that are dummy coded to reflect whether observations were missing or not for each previously defined linear component. Through these missing code variables, structural relationships between missing data and the target variable can also be modeled for each of the components. These missing code variables are also standardized to a mean of 0 and a standard deviation of 1.

2) cubic components: These constraints are formed by cubing each standardized vector xᵣ from constraint set 1 with the exception of the missing code variables. If the original input variable that formed the linear variable was a binary variable, these components will not be independent from linear components and are dropped. When missing data are present, imputation is performed as in Constraint Set 1.

3) quadratic components: These constraints are formed by squaring each of the standardized vectors from constraint set 1 with the exception of the missing code variables. If the original input variable that formed the linear variable was a binary variable, these components will not be independent from linear components and are dropped. When missing data are present, imputation is performed as in Constraint Set 1.

4) quartic components: These constraints are formed by taking each of the standardized vectors from constraint set 1 to the 4^{th} power with the exception of the missing code variables. If the original input variable that formed the linear variable was a binary variable, these components will not be independent from linear components and are dropped. When missing data are present, imputation is performed as in Constraint Set 1.

Symmetrical Error Constraints on Cross Product Sums

With these moment definitions, two additional sets of linear constraints are now imposed in this maximum entropy formulation above. These are constraints on w:

$$\begin{matrix}{\sum }_{j = 1}^{C} [ {\sum }_{r = 1}^{M} {s}_{r} {w}_{j 1 r} - {\sum }_{r = 1}^{M} {s}_{r} {w}_{j 2 r} ] = 0 & ( 6 ) \\ {\sum }_{j = 1}^{C} [ {\sum }_{r = 1}^{M} {w}_{j 1 r} - {\sum }_{r = 1}^{M} {w}_{j 2 r} ] = 0 & ( 7 )\end{matrix}$$

where sᵣ is equal to 1 for the linear and cubic group of data constraints and −1 for the quadratic and quartic group of data constraints. Equation (6) forces the sum of the probabilities of error across the linear and cubic components to equal the sum of the probabilities of error across all the quadratic and quartic components. Equation (6) groups together the linear and cubic constraints that tend to correlate and matches them to quadratic and quartic components in likelihood of error. Equation (6) is akin to assuming that there is no inherent bias in the likelihood of error in the linear and cubic components vs. the quadratic and quartic components. Equation (7) forces the sum of the probabilities of positive error across all M moments to equal the sum of the probabilities of negative error across these same moments. Obviously, the constraints of Equations (6) and (7) are more likely to reflect reality as the number of moments increases. Yet, when there are relatively few moments, the scale factor Ω is relatively small in magnitude, so these error constraints will not have significant influence on the maximum likelihood solution as in this case the solution will be similar to the standard maximum likelihood solution. Note that any given w element in Equations (6) and (7) can be removed from these constraints, so we can have an unequal number of terms corresponding to odd and even polynomials. This is important in variable deletion processing where we wish to selectively drop individual variables from the model and their corresponding error probability terms.

Form of Solutions

The probability components in the solutions have the form:

$$\begin{matrix}{p}_{ij} = exp ( {β}_{j 0 } + {\sum }_{r = 1}^{M} {β}_{jr} {x}_{ijr} ) / ( 1 + {\sum }_{j = 1}^{C - 1} exp ( {β}_{j 0} + {\sum }_{r = 1}^{M} {β}_{jr} {x}_{ijr} ) ) & 8 ) \\ {w}_{j 1 r} = exp ( {β}_{jr } {u}_{r} + {λ}_{j} + {τ}_{j} ) / ( 1 + {\sum }_{j = 1}^{C - 1} exp ( {β}_{j r} {u}_{r} + {λ}_{j} + {s}_{r} {τ}_{j} ) & 9 )\end{matrix}$$

However, for the reference condition where j=C, the solutions have the normalization conditions described by Golan et al. (1996) where the vectors β_{c} and λ_{c} and τ_{c} are zero for all elements r=1 to M. Hence, the solution at j=C takes the form:

$$\begin{matrix}{p}_{ij} = 1 / ( 1 + {\sum }_{j = 1}^{C - 1} exp ( ( {β}_{j 0} + {\sum }_{r = 1}^{M} {β}_{jr} {x}_{ijr} ) ) ) & 11 ) \\ {w}_{j 1 r} = 1 / ( 1 + {\sum }_{j = 1}^{C - 1} exp ( {{β}_{j r}}^{ur} + {λ}_{j} + {s}_{r} {τ}_{j} ) ) & 12 ) \\ {w}_{j 2 r} = 1 / ( 1 + {\sum }_{j = 1}^{C - 1} exp ( - {{β}_{j r}}^{ur} - {λ}_{j} - {s}_{r} {τ}_{j} ) & 13 )\end{matrix}$$

Where λ and τ are vectors of the solution parameters related to the two symmetrical sample error constraints across the C−1 choice conditions (Equations 6 and 7); the elements of λ and τ do not exist for the case where r=0, so wⱼ₁ᵣ and wⱼ₂ᵣ also do not exist for this case where r=0. In addition, β is a matrix of solution parameters related to the data moment constraints (Equation 2).

Extension to Ordered Target Variables

The multinomial logistic regression method that is outlined in the previous sections can be extended to situations where the target variable is a rank or interval-categorized variable with more than two categories, rather than a non-ordered category variable. This extension is exactly as in standard maximum likelihood logistic regression. That is, the probability estimates p and w now reflect cumulative probabilities across the C interval categories. As in standard ordinal logistic regression or what is called cumulative logit in SAS (see SAS 9.1.3 manual), an assumption is made that there is a linear relationship between the log odds of categories and the different values of the ordinal target variable. As a result, there is only one logit coefficient for each of the r variables βᵣ, without regard to the number of ordinal categories. However, the number of potential intercept coefficients will continue to be C−1, as in the non-ordinal category model (Equation 5).

In addition, the definitions of uᵣ and Ω as defined in Equations (5a) and (5b) above now need to be modified to handle error from an ordinal category target variable. This is accomplished by these new definitions:

$$\begin{matrix}{u}_{r} = Ω / sqrt ( ( {N}_{r} , - 2 ) / ( {N}_{r} - 2 ) ) ( {r}_{r} \sqrt{{N}_{r} - 2} / \sqrt{1 - {r}_{i}^{2}} ) for r = 1 to M , \\ where Ω is defined as \text{:} & 5 c ) \\ Ω = {\sum }_{r = 1}^{M} \vert {r}_{r} \vert \sqrt{{N}_{r} - 2} / \sqrt{1 - {r}_{r}^{2}} sqrt ( ( {N}_{r} , - 2 ) / ( {N}_{r} - 2 ) ) . & ( 5 d )\end{matrix}$$

where Nᵣ>2 where rᵣ>0 and rᵣ<1.

In these equations, rᵣ is the Pearson Product Moment Correlation between the Nᵣ non-missing values of the rth moment and the corresponding values of the interval category target variable where 0>r>1. The denominator in Equation (5c) is analogous to Equation (5a) in that this is at value that arises from a t-test, but this is now the standard t-test that is performed to determine whether a correlation is significantly different from zero. Unlike Equation (5a), Equation (5c) does not assume that the target variable is categorized in a binary or multinomial non-ordered manner, so this equation is now suitable for ordinal category modeling when there are more than two categories. For these models with more than two ordinal categories in their target variable, the t value from the denominator in Equation (5c) is used in variable selection processing that involves the use of at value (see below).

Extension to Repeated Measures/Multilevel Designs

This method can be extended to situations where training observations are made in repeated measures or multilevel designs. That is, the meaning of the index i that designated “individuals” in the multinomial discrete choice formulation of Equation (2) can now be expanded to represent “individual measurements”. These “individual measurements” can be from the same individual at different points in time as in a repeated measures variable such as multiple items in a survey or experiment, or from different individuals within a multilevel variable such as a county or a state. Depending upon how each of the r moments are constructed, individual-level and aggregate-level moments can be formed to result in a repeated measure and/or a multi-level design. In contrast to non-repeated/multilevel designs, the critical distinction in repeated measures/multilevel designs is that the values of the input variables are no longer independent across all observations. Hence, the application to this repeated measures/multilevel design is very straightforward once one has an appropriate way to deal with non-independent observations of input variables through the appropriate adjustment in the expected error term related to the number of independent observations N_{r′} in Equations (5a), (5b), (5c) and (5d).

Equivalence Between Maximum Entropy and Maximum Likelihood Model

As shown by Soofi (1992) and Golan et al. (1996), the multinomial discrete choice model formulation based upon maximizing entropy is equivalent to the standard maximum likelihood discrete choice model. Hence, in actual practice, one can maximize entropy in the objective function or one can maximize the appropriate unconstrained log likelihood function that is the basis of maximum likelihood. This log likelihood function is:

$$LL ( p , w ) = {\sum }_{i = 1}^{N} {\sum }_{j = 1}^{C - 1} {y}_{ij} ln ( {p}_{ij} ) + ( 1 - {y}_{ij} ) ln ( 1 - {p}_{ij} ) + {\sum }_{l = 1}^{2} {\sum }_{r = 1}^{M} {\sum }_{j = 1}^{C - 1} ln ( {w}_{jlr} ) \qquad ( 1 a )$$

where the indices and parameters are defined as previously, but where pᵢⱼ and wₗⱼᵣ are cumulative probabilities in the case of an ordinal categorized target variable as also noted previously. This function in Equation (1a) is the function used in our implementations in SAS 9.1.3 and is equivalent to the expression given in Golan et al. (1996) with the exception that Equation (1a) includes summations over all error probability terms wⱼ₁ᵣ and wⱼ₂ᵣ whereas Golan et al. are able to drop the numerator of these error probability terms because they do not include symmetrical error constraints in their model. When all error probability terms are equal, this log likelihood function reaches its maximum value and this is equivalent to maximum entropy.

Therefore, given the equivalence between the maximum entropy and maximum likelihood solutions, whether the objective is to maximize entropy subject to linear constraints as in Equations (1-5), or to maximize an unconstrained log likelihood function as in Equation (1a), has no bearing on these reduced error solutions for a given variable set. The advantage of discussing RELR in terms of a maximum entropy subject to linear constraints model is that it gives a somewhat simpler and easier to present formulation. However, in our implementations to date, we have used SAS to compute both maximum entropy and maximum likelihood RELR models and have found these results to be equivalent. Yet, the maximal log likelihood computation is considerably faster and we expect that this will be generally the case. For this reason, we prefer to maximize log likelihood in our implementation of RELR and we will refer to this throughout the rest of this application.

Variable Selection

The purpose of variable selection is to reduce the dimensionality of the problem into a manageable number of variables in a solution that contains the set of most important variables. The basic idea is to capture the subset of variables that would have the largest magnitude logit coefficients in a full model, while excluding those variables with smaller magnitude logit coefficients. In this way, we can build a model with a much smaller set of variables than with the entire set. This variable selection process arises from a set of relationships in the preceding equations. For example, from Equations (9) and (10) and properties of the natural log, and if we assume that we have all independent observations such that N_{r′}/Nᵣ=1, we have:

ln(w₁ⱼᵣ/w₂ⱼᵣ))=2βⱼᵣuᵣ+2λⱼ+2sᵣτⱼ 14)

Equation (14) reflects the logit or log odds of the error probability. Hence, we can consider the right hand side of Equation (14) to be the error for the rth moment and jth choice condition that is described in this reduced error model and write uᵣ in terms of Ω/tᵣ:

εⱼᵣ=2βⱼᵣΩ/tᵣ+2λⱼ+2sᵣτⱼ 15)

There is a basic relationship between tᵣ and the logit coefficient βⱼᵣ that follows algebraically simply by rearranging Equation (15):

(tᵣ/Ω)(εⱼᵣ/2−λⱼ−sᵣτⱼ)=βⱼᵣ 16)

Now, the expected value of εⱼᵣ is zero, as this implies that the positive error probability wⱼ₁ᵣ and negative error probability wⱼ₂ᵣ are equal. Therefore, if εⱼᵣ is small in magnitude as expected and in relationship to the magnitude of −λj−sᵣτⱼ, then we know that the following relationship will hold where εⱼᵣ has been set to zero:

(tᵣ)(−λⱼ−sᵣτⱼ)/Ω≈βⱼᵣ 17)

Since we also know that the expression −λⱼ−sᵣτⱼ corresponding to all linear and cubic components will be equal across all r=1 to M/2 moments for each of the jth choice conditions. This same expression will also be equal across all quadratic and quartic components corresponding to r=M/2+1 to M moments for each of the jth conditions. This simply follows from the definitions of these various components. If only linear components are included in a model, then this same expression also would be equal across all linear components for each jth condition. Therefore, we can use this relationship to select the linear and cubic moments with the largest magnitude logit coefficients for each of the jth choice conditions simply in terms of the magnitude of tᵣ. Likewise, we can select the largest magnitude logit coefficients for all quadratic and quartic moments simply in terms of this same magnitude, as this rank ordering also will correspond to the rank ordering of the magnitude of their βⱼᵣ coefficients across the r=M/2+1 to M moments for each of the jth choice conditions.

In fact, we expect that the relationship in Equation (17) to be a very good approximation when Ω gets large. This is due to the linear relationship in Equation (2) which suggests that if we substitute uᵣ=Ω/tᵣ, then as Ω gets larger, w₁ⱼᵣ and w₂ⱼᵣ must become closer to being equal, so that at very large Ω they are substantially equal. However, this relationship in Equation (17) could be a poor approximation for models with small numbers of important variables as given by small values of Ω, as in this case the error εⱼᵣ is not necessarily close to zero. However, given that the expected value of εⱼᵣ is zero, we can assume that, on average, tᵣ would be correlated with βⱼᵣ, although there is not necessarily be a tight linear relationship between tᵣ and βⱼᵣ for small values of Ω.

Nevertheless, we do actually want to impose a structure on models with small numbers of important variables as given by a small Ω that makes them more likely to select variables with large magnitude tᵣ. The reason is that many small Ω models will simply be underspecified because we cannot measure all of their most important input variables, so their actual logit coefficient magnitude ordering would follow large Ω rules based strictly upon tᵣ magnitudes if we had complete information. Another reason that we wish to impose this variable selection structure is that the importance of variables based upon relative tᵣ magnitudes is likely to be a stable measure across randomly split samples, even with small sample sizes. Such stability is an implicit feature of variable importance. For these reasons, any variable selection structure that we impose on small Ω models based upon the magnitude of tris desirable, so we select variables for all models using the variable importance rules embodied in Equation (17) with the caveat that the tᵣ values are weighted tᵣ values when sqrt(N_{r′}/Nᵣ) is not equal to 1 and this weighting would be in line with the weighting of tᵣ in the denominator of Equations (5a) and (5c). That is, a weight of sqrt(N_{r′}/Nᵣ)) would be used if the target variable category is non-ordered, whereas a weight of sqrt((N_{r′}−2)/(Nᵣ−2)) would be used if the target variable category is ordered.

Hence, we can write the following set of steps to define our variable selection method:

1. start with the M/2 most important odd numbered polynomial variables and M/2 most important even numbered polynomial variables as defined by the magnitude of the weighted t value that reflects the strength of their relationship to the target variable;

2. build a RELR model with these variables through the formulation described in this application and record its Log Likelihood computed as in Equation (1a);

3. drop the odd numbered polynomial variable and even numbered polynomial with the smallest t value magnitudes and drop the pseudo-observations corresponding to this variable that reflect its positive and negative error terms;

4. repeat steps 2-4 until we have dropped all variables,

5. of all the models across the variable sets, take the model with the largest Adjusted Log Likelihood as the best model.

The Adjusted Log Likelihood is the Log Likelihood defined by Equation (1a) that is adjusted so that the product 2M_{d}(C−1)Ln(1/C) is added to the Log Likelihood where M_{d} reflects the number of variables dropped prior to that model and C reflects the number of categories. This has the effect of producing a model where the error probability terms w₁ⱼᵣ and w₂ⱼᵣ corresponding to all dropped variables are not dropped but instead are set to their expected values. In this way, models with differing numbers of variables will all have the same number of error probability terms contributing to their Adjusted Log Likelihood. This Adjusted Log Likelihood does not necessarily increase with increasing numbers of variables, so it can be used as a measure of goodness of fit across solutions with differing numbers of variables.

Hence, we can start with a subset of all possible variables as defined by our initial assessment of the rank order of weighted t values corresponding to each possible variable, build a model, and gradually drop variables to create successively smaller sets of variables in new successive models. We do this by dropping variables corresponding to the least important odd and even numbered polynomial components at each step in the variable screening process, rebuild the model, and then check its Adjusted Log Likelihood. We define the importance of the variables through the magnitude of weighted t-values. At the end of this screening process, we want the variable set with the largest Adjusted Log Likelihood. If there is a tie in the Adjusted Log Likelihood across different numbers of variables, we want the variable set with the smallest number of variables.

The choice of the starting number of variables as given by the M parameter ideally should be made to allow an M as large as possible, given the processing time constraints on running the model. However, in reality, choices of M that are larger than half the number of observations in the smaller of the target vs. non-target condition groups often give models that overfit, so the starting value of M is set below this level to avoid overfitting.

Once again, the ordering of the magnitude of t-values is relatively stable in randomly split samples with a minimum number of observations in the smaller sample. Therefore, we allow the user to use only a small fraction of the entire training sample to construct the weighted t values. This potentially allows an enormous savings in computational time in the variable selection phase. For example, if we are able to get reliable weighted t values with only 1% of the training sample, the variable selection phase should run in roughly 1% of the time as would be required to compute t values based upon the entire training sample.

Hierarchical relationships between input variables and their interactions are often assumed in some types of applications such as genomic applications (Park & Hastie, 2006). For example, some genomic models have not allowed any variables other than linear variables to be entered into a model. In addition, in these genomic models, the hierarchical relationship does not allow an interaction to be selected in a model without all variables that compose the interaction also being selected. The method of the present application allows for such hierarchical rules for variable selection. In particular, if a user so chooses, each variable set selected can be constrained so that interactions terms are only allowed when all constituent variables are also present. The effect of this is that multiple variables can be dropped at each step in the variable selection process because if a constituent variable is dropped, then all of its interaction terms are also dropped. The method of the present invention can do this through its variable selection process, as long as entirely linear variables are employed. Likewise, hierarchical rules might also be employed in the variable deletion process define below. Users have control over whether or not to exercise this option.

Variable Deletion

The variable selection process described above does not attempt to reduce any redundancy in variables. This is the purpose of variable deletion. In many cases, we can delete a large set of variables and have the same or a better fit. The purpose of variable deletion is to generate the smallest set of variables with the greatest Adjusted Log Likelihood score. The process works as follows:

1. start with the model with the maximal Adjusted Log Likelihood from the variable selection phase as the initial model.

2. drop the variable with the smallest Chi-Square result that measures the effect of that variable on the likelihood. The Chi-Square could be based upon the Wald measure as in SAS 9.1.3 software. It could be based upon a more time consuming Likelihood Ratio Test also available in SAS 9.1.3 software. Or, it could be based upon any such comparable process that attempts to measure an individual variable's effect on the likelihood through a Chi-Square.

3. build a RELR model with these variables using the same scale Ω that resulted from the best model from the variable selection phase and record the Log Likelihood computed as in Equation (1a);

4. repeat steps 2-4 until all variables have been dropped;

5. of all the models across the variable sets, take the model with the largest Adjusted Log Likelihood as the best model where the Adjusted Log Likelihood is as defined previously.

In the case of a non-ordered category model with more than two categories, we reset the model to look only at the reference vs. non-reference categories as if it were a binomial model through this variable deletion process. The reference category is, as defined previously, the category with the largest number of responses. As a final step in this type of model, we run the full multinomial discrete choice model with the remaining variables and then have logit coefficients βⱼᵣ for all j=1 to C−1 categories in our target variable. This special condition is necessary because we do not want to drop alternatives corresponding to individual choice conditions in variable deletion, but instead want to drop variables. This special condition is obviously not necessary for ordered/cumulative logit models, as in that case there is only one logit coefficient per variable.

Use of the Method

What follows are examples of the use of the method of the invention.

Computation of Solutions

The solutions that are reported here used Proc Genmod and Proc Logistic in SAS although RELR can be implemented in any computer process that maximizes entropy/likelihood whether it is a software language or a computer hardware process. The comparison methods were evaluated using SAS Enterprise Miner.

Example Bush vs. Kerry Models Based on a Political Polling Dataset

Data were obtained from the Pew Research Center's 2004 Election Weekend survey. The survey consisted of a representative sample of US households. Respondents were asked about their voting preference on the weekend before the 2004 election. 2358 respondents met the criteria of this example model which only employed those respondents who indicated that they would vote for Bush or Kerry without regard to whether Nader was in the race. In addition to voting patterns, this survey collected demographic and attitude data. These demographic and attitude responses were employed as input variables in the predictive models. Examples of attitude questions were whether respondents agreed with the Iraq war and whether respondents thought that the US was winning the war against terrorism.

The target variable was Presidential Election Choice (Bush vs. Kerry). Kerry was the target condition. There were 11 interval variables and 44 nominal input variables originally, but the nominal variables were recoded into binary variables for input into RELR. RELR also produced new input variables from these original input variables corresponding to two-way interactions and polynomial terms where appropriate. Over 1500 variables resulted in total; the 400 most important variables were input into the model. This corresponded to the 200 most important linear/cubic variables and the 200 most important quadratic/quartic variables as a starting condition. Variables were then selected and deleted in accordance with the RELR variable selection and deletion methodology that has been previously outlined. The models were run within SAS Enterprise Miner 5.2 using the extension node methodology.

Bush vs. Kerry models were also run within Enterprise Miner 5.2 using the Support Vector Machine, Partial Least Squares, Decision Tree, Standard Logistic Regression and Neural Network methods. The default conditions were employed in all cases except Standard Logistic Regression where two way interactions and polynomial terms up to the 3^{rd} degree were specified and Support Vector Machines where the polynomial method was requested. In addition, the Imputation Node within Enterprise Miner was employed with the Regression and Neural Network methods and was run using its default parameters. The identical variables and samples were employed as inputs in all cases. Misclassification Rate was employed as the measure of accuracy in all cases.

In a first “smaller sample” model, the training sample consisted of a random sample of 8% or 188 observations. The remainder of the overall sample defined the validation sample. In a second “larger sample” model, the training sample consisted of a random sample of roughly 50% or 1180; the remainder of this sample defined the validation sample. The 2004 election was very close, as roughly 50% of the respondents opted for Kerry in all of these sub-samples. Target condition response numbers are indicated in the results charts.

Like most political polling datasets, there was a wide range in the correlation between the original input variables that went from roughly −0.6 to about 0.81. These correlation magnitudes were even larger for many of the interactions produced by RELR, so this dataset clearly exhibited multicollinearity. In addition, there was significant correlation to the target variable in a large number of variables. Hence, this dataset contained many informative variables.

Results of Bush vs. Kerry Models Based on a Political Polling Dataset

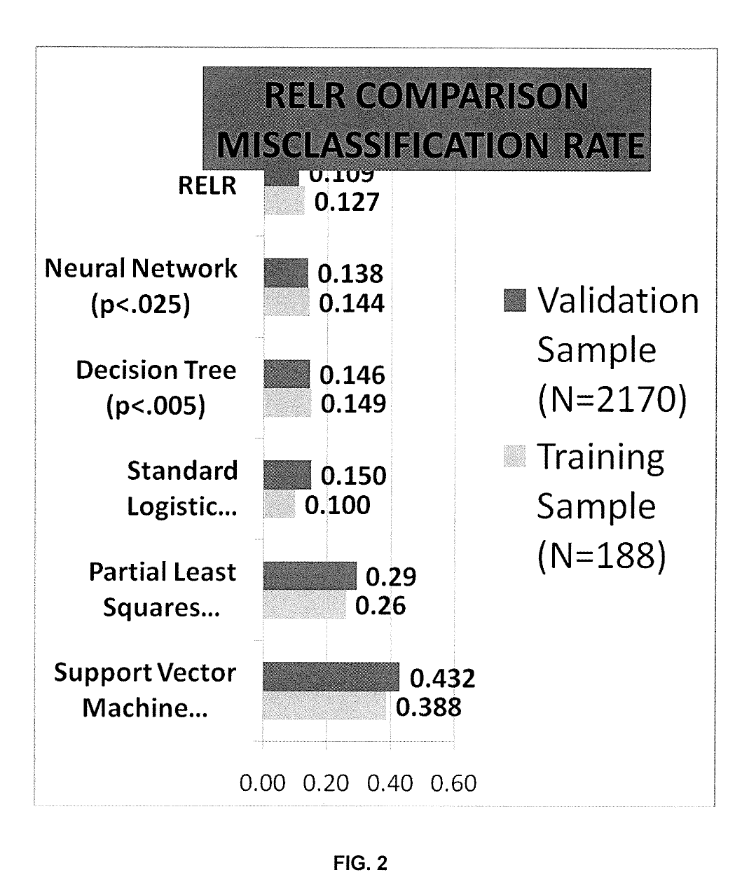

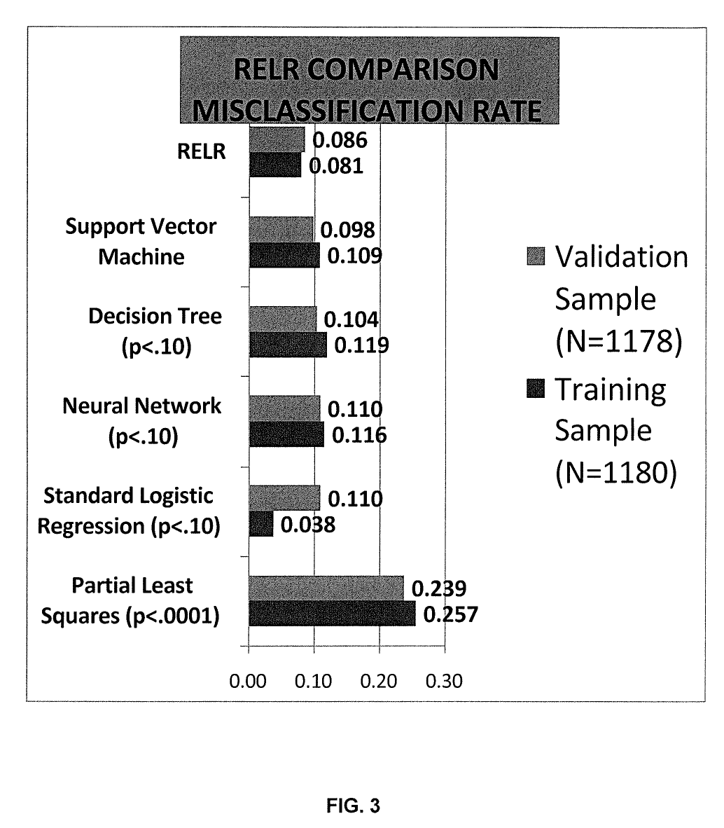

FIG. 2 compares the accuracy of RELR to the other predictive modeling methods in the Bush vs. Kerry “small sample” model. The significance levels in that figure are from chi-square tests that compare these misclassification proportions using McNemar's test for dependent proportions in the validation sample. FIG. 3 shows these same comparisons for the Bush vs. Kerry “large sample” model. These results suggest that RELR had better validation sample accuracy than a set of commonly used predictive modeling methods that include Standard Logistic Regression, Support Vector Machines, Decision Trees, Neural Networks, and Partial Least Squares, but that these effects are most pronounced with the smaller sample size of training observations. These results suggest that RELR's advantageous effects become most pronounced as more error is present as in the case with a smaller sample size of observations.

Example Model Based on PTEN Stock Price Data

Stock price data from Patterson Energy (NASDAQ symbol: PTEN) from Aug. 11, 1997-8/8/2006 were collected through the Reuter's Bridge Workstation QuoteCenter Product. Six variables that reflected the very short term price trend of PTEN were employed. They measured the % change between its opening price and recent other price points such as previous open price, its previous close price, and its previous high. From these six interval variables, 130 other variables were computed based upon up to 3 way interactions and 4^{th} order polynomials. Variables were then selected and deleted in accordance with the RELR variable selection and deletion methodology that has been previously outlined. 84 variables were the input variables. The target variable was based upon the % change in PTEN's price from one day's opening to the next day's opening. This variable was encoded into a binary target variable that reflected whether the stock price went up or down. An interval target variable would have also been appropriate. We found similar results when we used the Ordinal Logit formulation of Generalized RELR on interval-categorized encoding, but we wanted to use a binary target variable so we could continue to use Misclassification Rate to compare to other predictive modeling methods within SAS Enterprise Miner.

In general, these input variables in this model were not highly correlated to stock price % change and to its binary transform. These input variables would largely be classified as relatively non-informative variables.

Results of PTEN Stock Price Data Model

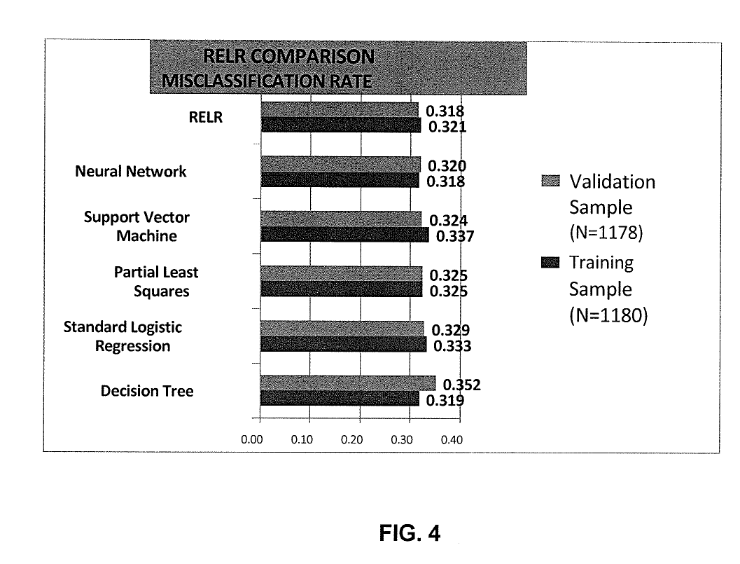

FIG. 4 compares the accuracy of RELR to the other predictive modeling methods in this PTEN model. There were no statistically significant differences between these methods with regard to classification error. This is consistent with the small number of informative variables in this PTEN dataset, as RELR would not be expected to enhance model performance in such situations.

In view of the above, it will be seen that the advantages of the invention are achieved and other advantageous results obtained.

1. A method for machine classification learning comprising:
a computational process that uses a multi-layer feedforward network structure that includes input, decision and output nodes connected through hardware or software in a computational device such as a computer.

2. The method of claim 1 in which the computational device comprises a robot.

3. This method of claim 1 incorporating a feedback from the output nodes.

4. The method of claims 1 and 2 that allows the computer or robot to be trained to learn a reduced error maximum likelihood logistic regression match to a target class variable based upon a plurality of input variables so to exhibit classification learning;

5. The method of claim 4 in which an output from the computer or robot comprises the most likely target category resulting from the classification learning.

6. The method of claim 5 for use by robotic engineers might use to build classification learning into a robot.

7. This method of claim 1 further including selecting input variables in accordance with the expected importance of each variable based upon preselected criteria; and in which redundant input variables are deleted, so to achieve a maximal adjusted log likelihood match to the data being processed.

8. The method of claim 1 in which the selection of variables used in choosing the data samples is automated so to reduce dimensional problems in performing the generalized reduced error logistic regression to a manageable size.

9. The method of claim 1 in which solutions are optimally scaled so to achieve relatively greater accuracy than results obtained using other methods.

10. The method of claim 1 which allows repeated and multilevel measures of observational designs.

11. The method of claim 1 which is used with binary target variables.

12. The method of claim 1 which is used with multinomial target variables regardless of whether the variables are in ordered or non-ordered categories.

13. The method of claim 1 in which using a generalized reduced error logistic regression produces a maximum likelihood based logistic regression that substantially eliminates problems of multicollinearity which are inherent machine learning involving a plurality of input variables.

14. The method of claim 1 further including performing successive iterations of the reduced error logistic regression using variable selection and variable deletion, and wherein performing the method starts with a relatively large set of variables which are gradually reduced by deleting the least significant variables after each iteration so to eventually define a best model based upon an adjusted log likelihood.

15. The method of claim 1 for use in building predictive models.

16. The method of claim 1 further including accessing those statistics which underly the computational process at any stage of processing, the accessing including accessing statistics involved in a decision node including the probability of a match in any given category, estimates of reduced error cross product sums, regression coefficients and their expected error, error statistics such as expected misclassification percentages or estimated error on original cross product sums, adjusted log likelihood, and any other measures of model error or parameter confidence intervals.

17. The method of claim 16 further including usage in predictive modeling and/or analytical applications, and usage of statistics resulting from the method including estimates of reduced error cross product sums corresponding to input variables and any estimates of means or proportions or other descriptive statistics that are derived from these estimates of reduced error cross product sums at any stage of processing.

18. The method of claim 1 where higher order components than 4^{th} order polynomial components for the information probabilities and/or higher order components than linear components for the error probabilities are measured and employed in a way similar to this method.
